(19) United States
(12) Patent Application Publication
(10) Pub. No.: US 2010/0119033 A1
(43) Pub. Date: May 13, 2010

(54) INTENSITY-MODULATED, CONE-BEAM COMPUTED TOMOGRAPHIC IMAGING SYSTEM, METHODS, AND APPARATUS

(75) Inventors: King C. Li, Houston, TX (US); Xiaobo Zhou, Bellaire, TX (US); Goetz Benndorf, Houston, TX (US)

Correspondence Address: HAYNES AND BOONE, LLP;IP Section, 2323 Victory Avenue, Suite 700, Dallas, TX, 75219, US

(73) Assignee: THE METHODIST HOSPITAL RESEARCH INSTITUTE, Houston, TX (US)

(21) Appl. No.: 12/617,510

(22) Filed: Nov. 12, 2009

Related U.S. Application Data
(60) Provisional application No. 61/113,655, filed on Nov. 12, 2008.

(51) Int. Cl. H05G 1/60; G21K 1/02

(52) U.S. Cl. 378/5; 378/147; 378/4

(57) ABSTRACT

Disclosed are methods for reconstructing a three-dimensional image of an object's volume of interest using computed tomography that employs conical-beam, intensity-modulated projections of this object. In one embodiment, a plurality of collimating devices serves to modulate the aperture of the radiation source thereby acting to modulate the intensity of the source upon the object. Also provided are image processing devices, examination apparatus, as well as a computer-readable medium and a program element adapted and configured to perform aspects of the methods disclosed herein.

### CROSS-REFERENCE TO RELATED APPLICATIONS

The present application claims priority from U.S. Provisional Application No. 61/113,655, filed Nov. 12, 2008; the entire contents of which is specifically incorporated herein by express reference thereto.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to the field of computed tomography (CT). In particular, the present invention provides a method of reconstructing a three-dimensional image of an object's volume of interest from a set of conical-beam, intensity-modulated projections of this object. Also provided are image processing devices, examination apparatus, as well as a computer-readable medium and a program element that is adapted and configured to perform aspects of the methods disclosed herein.

2. Description of Related Art

Compared to traditional slice-at-a-time tomographic instruments, the cone-beam (CB) CT offers faster scans, higher patient throughput, significant reduction in X-ray dosage, and isotropic resolution. It has a great potential to be applied to a wide range of medical and industrial applications.

Cone-beam computerized tomography (CBCT) with flat panel detectors (FPD) has become a prevalent three-dimensional (3-D) imaging system for clinical application. Its short time acquisition and reconstruction with mobile C-arm system allow the integration of 3-D imaging into the interventional procedures such as endovascular techniques. In comparison with image intensifiers, the flat panel detectors provide no geometrical distortion, a higher dynamic range, and homogeneous signal distribution¹. The Feldkamp, Davis, Kress (FDK) algorithm² and its modifications in the filtered-backprojection (FBP) family have been implemented for reconstructing approximate 3-D images from circular CB projection data. Correction algorithms such as scatter correction, beam hardening correction, truncation correction, and ring correction have been developed for removing artifacts of reconstructed image prior to and after FDK reconstruction algorithm³.

Because an X-ray tube generates X-rays in all directions, beam restrictors such as collimators or aperture systems are set up in the X-ray tube for absorbing unnecessary X-ray beams outside field of view (FOV). Satisfactory CBCT systems employing collimators to reduce radiation exposure, however, have not been implemented. As CBCT scans become more common, patients are exposed to greater amounts of X-ray radiation. This exposure carries an increased risk for developing cancer, especially for children and for individuals who require multiple scans. In most cases, the region of interest for diagnosis is smaller than the window of exposure to radiation, meaning that healthy surrounding tissue receives a full dose of radiation despite not being used in the diagnosis of the patient's condition. Current CT scanning technology, unlike certain other scanning technologies, does not allow for shaping the window of exposure because of the complexity of interpreting less than the full radiation dosage across the imaging detectors.

### BRIEF SUMMARY OF THE INVENTION

The present invention overcomes these and many other limitations inherent in the prior art by providing, inter alia, intensity-modulated conical-beam CT imaging methods that significantly lower the overall radiation exposure during a computed tomography (CT) scan. The disclosed methods also provide a mechanism for interpreting a collimated, intensity-modulated beam, thus enabling a medical practitioner to narrow the window of radiation exposure to encompass only the particular region of interest to be imaged.

Unlike conventional CT instrumentation that uses constant beam intensity for every projection angle to produce the final image, the present invention provides an aperture, such as a collimator, to modulate the intensity of the X-ray beam, thereby reducing the amount of radiation impinging on the object of interest. In the case of medical CT imaging, the methods result is significantly lower background radiation, and a reduced level of radiation exposure to surrounding tissues, while still maintaining a sufficient intensity for imaging the target tissue. CT instrumentation employing aperture-controlled CB energy provides overall reduction in radiation exposure, which is expected to lessen the risk of adverse effects, including carcinogenesis, in the patient undergoing CBCT imaging and examination.

In illustrative embodiments, the method is accomplished using one or more aperture-controlling and/or beam intensity-restricting or limiting devices, such as, for example, a plurality of collimators, preferably placed between the radiation source and the object, to modulate the intensity of the energy beam. Modulation of the beam intensity using the intensity modulating device is accomplished such that one or more regions of interest (ROI) (alternatively referred to as a “volume of interest” [VOI]) for which analysis and imaging is desired, receive a dose of radiation sufficient to effect the desired imaging characteristics, while the surrounding tissue outside the ROI/VOI receives much lower (i.e., attenuated) ancillary radiation. By narrowing the target “window” to encompass substantially only the ROI/VOI, the present invention significantly improves the quality of diagnostic imaging, while also reducing the risk(s) that are inherent to a patient undergoing imaging using modalities (such as CT) that employ ionizing radiation.

The purposes for applying collimation to CBCT are to reduce exposing areas of patients that need not be imaged and to moderate the scatter effect, which degrades image quality⁴. Collimators can be designed as variable diaphragms composed of movable pieces of metal. They include two movable pieces of metal in the longitudinal direction (perpendicular to the plane of X-ray source trajectory) and two in the transverse direction (tangential to the circle of X-ray source trajectory). The relation between scatter effect and collimation on different organs of a phantom has been previously demonstrated⁵. The experimental results showed that scatter-to-primary ratio decreases when FOV in the longitudinal direction is reduced. Moore et al. calculated the contrast-to-noise ratio (CNR) of a targeted area using aluminum-made filters and lead-made collimators with varying thickness and with different fan angles of FOV in the longitudinal direction⁶. The present invention demonstrates significant improvements in CNR can be achieved when using collimated beam intensity-modulated imaging versus traditional non-collimated CT imaging methodologies and instrumentation.

In an overall and general sense, CT systems capable of providing data for reconstructing a three-dimensional (3-D) object using one or more rotations with an intensity-modulatable beam of radiation, typically include a source of X-rays distributed along a line parallel to an axis of rotation, an aperture control positioned perpendicular to the axis of rotation and near the x-ray sources so to limit the X-rays illuminating the object to contain only X-rays that travel substantially along lines perpendicular to the axis of rotation, and a detector for detecting and measuring transmitted X-rays emitted by the source. In illustrative embodiments, the aperture for controlling the size of the CB may include one or more collimators to restrict the X-rays primarily to impinge primarily upon the ROI/VOI in the object being imaged. Exemplary collimating devices may include one or more arrays or pluralities of collimators, positioned to modulate the intensity of the radiation source. In certain embodiments, the collimators may include a plurality of flat collimator plates, blades, lamellas, gates, vanes, irises, pinholes, or windows, or any combination thereof, including without limitation, those composed of a piece of dense plastic, composite, alloy, or metal, including, without limitation, aluminum, lead, or tungsten, that effectively block at least a first portion of the beam from reaching the object.

In a first embodiment, the invention provides a method for operating computed tomographic imaging using a radiation source and a plurality of detectors to generate an image of an object. In an overall and general sense, this method involves one or more steps including a) defining desired image characteristics; b) performing calculations to determine the modulation intensity to be applied to a radiation source by at least a first collimator to generate the desired image characteristics; and c) modulating the radiation source using the at least a first aperture system or collimator device to generate a desired pattern of fluence between the beam source and the object to be imaged. Exemplary desired image characteristics include, without limitation, desired levels of contrast-to-noise ratio (CNR), signal-to-noise ratio (SNR), or a combination thereof. The method may involve providing at least one desired image quality in at least one defined region of interest, or alternatively, providing at least a desired plurality or distribution of images or image qualities. In certain applications, the step of performing the calculations will include solving an inverse problem using one or more iterative solutions. Such methods may also further optionally include a step of defining at least a first region of interest from a library of population modules, or from at least one previously acquired image of the object.

In the practice of these methods upon animal (and preferably, human) subjects, the total radiation dose to the organism will be lower (and in some cases substantially lower) than that typically required performing a similar method in the absence of intensity modulation, and/or without using at least one modulatable aperture or collimator device to modulate the intensity and fluence of the radiation beam emanating from the radiation source.

In certain embodiments, the method will include providing at least a first temporal modulation of the radiation source, at least a first spatial modulation of the radiation source, or a combination of both spatial and temporal modulation of the radiation source.

In exemplary embodiments, the collimator will include a plurality of individual elements adapted to absorb radiation, and in some instances, this plurality of individual elements is composed of lead or other such like element, compound, or composition.

In another embodiment, the invention provides an imaging system adapted and configured to perform one or more of the methods described herein. In the practice of the invention, the imaging system may include at least a first collimator that is composed of two or more individual elements, each of which is substantially impervious to the radiation, and being substantially movable between an open position and a closed position, whereby open positions of the individual elements within the collimator define an aperture that permits passage of the beam from the radiation source to impinge upon the object being imaged. Such imaging systems include, without limitation, CT systems, and preferably, CBCT systems, including, without limitation, those CBCT systems in which a computer forms at least a first image using at least a first mathematical algorithm adapted and configured for obtaining and/or analyzing an image of an object of interest.

In certain embodiments, the imaging system will further optionally include one or more post-processing modules that may be useful in the enhancement of at least a first three-dimensional model of at least a first region of interest from on, or substantially within one or more portions of the object being imaged by the system. Preferably, the plurality of X-ray projections will originate from a circular, or even helical, trajectory of one or more X-ray radiation sources around, or in substantial proximity to, the object of interest being imaged.

In another embodiment, the invention provides a record carrier on which a computer program for the generation of a three-dimensional model of at least a first region of interest of an object from a plurality of collimated X-ray projections is stored. The record carrier preferably contains a computer program that is adapted to execute at least one, and preferably, substantially all of the iterative steps of one or more of the methods disclosed herein.

The invention also provides a computer-readable medium, onto which a computer program for reconstructing one or more three-dimensional image(s) of an object's ROI/VOI from a set of collimated CB X-ray projections of the object is stored. Preferably, the computer program, when being executed by a processor, is adapted to execute at least one, and substantially all, of the steps of one or more of the image acquisition and/or image analysis methods disclosed herein.

The invention, in another embodiment, also provides a program element for reconstructing a three-dimensional image of an object's ROI or VOI from at least a first set of CB X-ray projections of the object, which, when being executed by a processor, is adapted to execute at least one step, and substantially all, of the steps of one or more methods as disclosed herein.

In another embodiment, the invention provides an examination apparatus that includes (a) an X-ray device for the generation of X-ray projections of an object's region or volume of interest from at least two different directions, wherein the projections are obtained from at least two different samplings of a collimated beam of X-rays generated from the device; and (b) at least a first imaging acquisition or analysis device as disclosed herein. In one embodiment, the examination is characterized as a CBCT system, and is preferably adapted and/or configured to provide at least a first intensity-modulated (i.e., aperture-limited or collimated) beam of X-rays for imaging at least a first region of interest of an object that is undergoing examination in the apparatus by one or more technicians, operators, medical practitioners, or such like.

In exemplary embodiments, the examination apparatus as disclosed herein may be adapted or configured as a baggage inspection apparatus, a medical diagnostic apparatus, a material testing apparatus, or a materials science analytic apparatus, or such like.

The invention also further herein provides methods for generating three-dimensional images of an object using a plurality of CB projections that are passed through the object and attenuated thereby. In an overall and general sense, such methods include at least the steps of a) positioning a source at a position on a predetermined scan path; b) passing a projection of CB X-ray radiation comprising a plurality of projection rays from the source through an object, wherein the CB projection is attenuated by at least one or more collimators adapted and configured to attenuate the projection; c) detecting the radiation intensity of the CB projection passing through the object of interest onto an area of at least a first detector; d) obtaining a two-dimensional attenuation image of the CB projection from the detected radiation intensity; e) generating an intermediate, locally reconstructed, three-dimensional image with constant values assigned along each projection ray; f) at least once, repeating steps (d)-(e); and g) summing the plurality of intermediate, locally reconstructed, three-dimensional images obtained for the plurality of CB projections to obtain an ultimate, reconstructed, three-dimensional image of the object.

The invention also further provides a CBCT apparatus that includes: (a) at least a first radiation source, (b) at least a first radiation detector, (c) at least a first support for an object of interest, or alternatively, at least a first region of interest from such an object, to be illuminated by a collimated beam of radiation projected from the radiation source, and (d) at least one computer-readable storage medium for storing computer-executable software to generate a reconstruction of the CB radiation attenuation in the illuminated object. In such applications, the software will preferably include: (a) computer-executable code for obtaining and/or generating at least a first intermediate, locally reconstructed, three-dimensional image; (b) computer-executable code for summing a plurality of intermediate, locally reconstructed, three-dimensional images obtained for the CB projections to obtain an ultimate, reconstructed, three-dimensional image of the object; and (c) computer-executable code for displacing the source and detector relative to the support in a predetermined scan path for radiation transmitted from the source, through an object positioned by the support, and to the detector.

The invention also provides methods and systems for forming an image of an object that generally involves) exposing the object to a cone beam of radiation rendered spatially coherent by its passage through at least a first collimator; (b) projecting the spatially coherent collimated conical beam of radiation onto the object and collecting the radiation which has passed through the object in at least a first detector to produce detected data; (c) deriving, from the detected data, at least a first image; and (d) repeating step (c) at least once to form a plurality of images of at least a first region of interest within the object. Exemplary systems include, without limitation, CBCT system adapted and configured for medical diagnostic imaging and/or therapy.

According to another exemplary embodiment of the present invention, a computer-readable medium may be provided, in which a computer program for reconstructing an image from a set of projections of an object of interest with an examination apparatus is stored which, when being executed by a processor, is adapted to carry out the above-mentioned method steps.

The present invention also relates to a program element of reconstructing an image from a projection data set of an object of interest, which, when being executed by a processor, is adapted to carry out the above-mentioned method steps. The program element may preferably be loaded into the working memory of a data processor. The data processor may thus be equipped to carry out exemplary embodiments of the methods of the present invention. The computer program may be written in any suitable programming language, and may be stored on a computer-readable medium, such as a computer hard drive, a CD-ROM, DVD-ROM, or the like. In addition, the computer program may be available from a network, from which it may be downloaded into image processing devices or processors, or any suitable computer(s).

### BRIEF DESCRIPTION OF THE DRAWINGS

For promoting an understanding of the principles of the invention, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one of ordinary skill in the art to which the invention relates.

The following drawings form part of the present specification and are included to demonstrate certain aspects of the present invention. The invention may be better understood by reference to the following description taken in conjunction with the accompanying drawings, in which like reference numerals identify like elements, and in which:

FIG. 1A and FIG. 1B illustrate exemplary ROI imaging with truncation in accordance with one aspect of the present invention. In FIG. 1A the ROI imaging has larger FOV, and only several projections are truncated. The projections undergo mild truncation. In FIG. 1B, the ROI imaging has smaller FOV, and all projections are truncated. The projections undergo severe truncation;

FIG. 2 illustrates an exemplary ROI imaging with movable collimators in accordance with one aspect of the present invention;

FIG. 3A, FIG. 3B, FIG. 3C, and FIG. 3D illustrate an exemplary truncation correction in accordance with one aspect of the present invention. In FIG. 3A, the projection image without truncation and the coordinate definition is shown. In FIG. 3B, the projection image with truncation, and uᵣ and uₗ are the edges of the truncated projection are illustrated. In FIG. 3C, the illustration of extrapolation with mirror symmetry is shown; and in FIG. 3D the cosine weighting of (c) is shown;

FIG. 4A and FIG. 4B illustrate an exemplary π-line reconstruction in accordance with one aspect of the present invention. In FIG. 4A, the geometry and the trajectory in mid-plane is shown with z=0. In FIG. 4B, the π-line segments are defined as the chords on the circular trajectory which lies on the mid-plane z=0 and imaginary ones (dotted circles) which lies on the plane z≠0;

FIG. 5A, FIG. 5B, and FIG. 5C illustrate an exemplary entrance dose calculation in accordance with one aspect of the present invention. In FIG. 5A, the virtual entrance plane is defined at the top of the patients. In FIG. 5B, the geometry of projection onto the virtual plane, and in FIG. 5C, the obliquity effect is demonstrated;

FIG. 6 illustrates an exemplary geometry in the measurement of radiation dose in accordance with one aspect of the present invention. The head phantom is placed in the center of the trajectory with a chamber inserted at the center or at the peripheral;

FIG. 7A, FIG. 7B, FIG. 7C, and FIG. 7D show an exemplary FDK and π-line reconstruction of the mid-plane in accordance with one aspect of the present invention. In FIG. 7A, the FDK reconstruction is shown “without collimation” imaging. In FIG. 7B, the π-line reconstruction is shown “without collimation” imaging. In FIG. 7C, the FDK reconstruction is shown “with collimation” imaging with Cₜ=130 mm and Cₗ=130 mm. In FIG. 7D, the π-line reconstruction is shown “with collimation” imaging Cₜ=130 mm and Cₗ=130 mm;

FIG. 8A, FIG. 8B, and FIG. 8C illustrate an exemplary ROI reconstruction of the mid-plane in accordance with one aspect of the present invention. The reconstruction is done by truncation correction with the FDK algorithm. FIG. 8A shows the results without collimation. FIG. 8B shows the results with collimation, Cₜ=110 mm and Cₗ=77 mm; FIG. 8C illustrates the results with collimation, Cₜ=150 mm and Cₗ=83 mm;

FIG. 9 shows an exemplary calculation of entrance dose in accordance with one aspect of the present invention;

FIG. 10 shows an exemplary dose comparison of full-field versus FOV areas in accordance with one aspect of the present invention;

FIG. 11A and FIG. 11B illustrate an exemplary relation of π-line segments and ROI in accordance with one aspect of the present invention. FIG. 11A illustrates an object under ROI imaging with two π-line segments, L₁ and L₂. FIG. 11B illustrates that when the ROI was entirely within the object, every π-line segment, such as L₃, contains part of the object outside the ROI; and

FIG. 12 illustrates a schematic representation of an exemplary CBCT system in accordance with one aspect of the present invention.

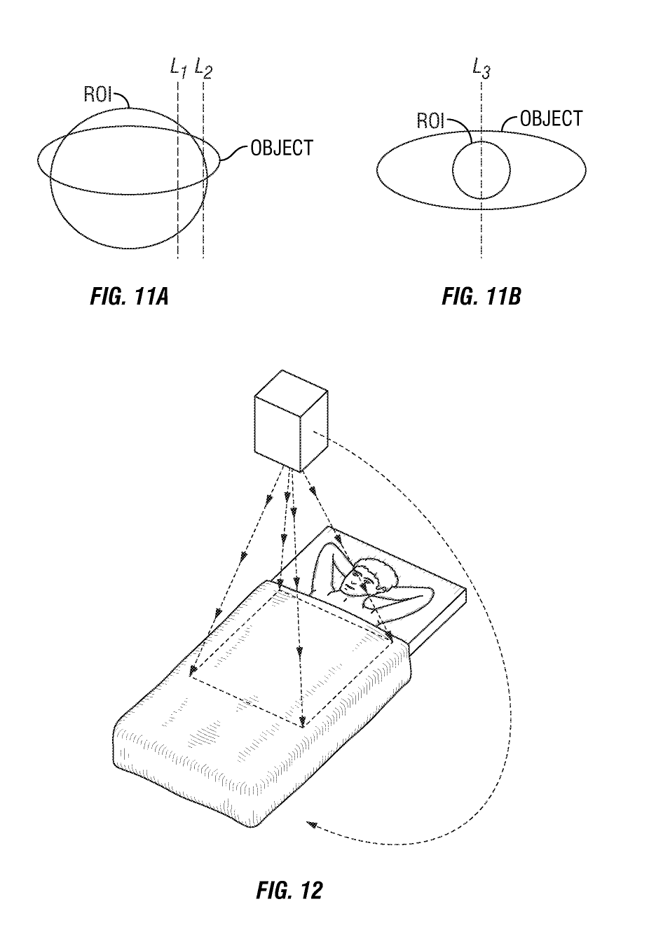

### DESCRIPTION OF ILLUSTRATIVE EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would be a routine undertaking for those of ordinary skill in the art having the benefit of this disclosure.

### Cone-Beam Computed Tomography (CBCT)

In CBCT, a set of X-ray cone-beam projections of an object's ROI is acquired while an X-ray source moves along some source trajectory around the object. Using a CBCT scanner, a 3-D image of the object's ROI can be reconstructed from this set of cone-beam projections. Conventional CBCT scanners are equipped with a point-like X-ray source and a large-area X-ray detector. Typically, the detector is flat and subdivided into a two-dimensional (2-D) array of small detector elements. Such a flat detector naturally defines a 2-D plane in 3-D space, i.e., the detector plane, which is rigidly attached to the detector and moves as the detector moves. The cone-beam is formed by those X-rays that emanate from the source and intercept the detector. A 3-D image is reconstructed from the set of cone-beam projections by means of an image-processing device, which is typically a computer that executes a computer program that implements a reconstruction algorithm. The reconstructed image provides a sampled estimate of the 3-D map of the X-ray attenuation coefficient within the ROI of the imaged object.

CBCT scanners may be realized in various ways, which are known to the person of ordinary skill in the medical imaging arts. U.S. Pat. Nos. 6,582,120 and 5,124,914 (each of which is specifically incorporated herein in its entirety by express reference thereto) illustrate examples of conventional arm-based and gantry-based CBCT apparatus. C-arm based scanners are normally equipped with a flat detector, while gantry-based scanners have either flat or non-flat detectors. Flat detectors have natural detector planes associated with them that are usually subdivided into a 2-D array of small detector elements. In such a case, each CB projection of the acquired set of CB projections will be sampled on an equidistant Cartesian grid in the detector plane. In non-flat detector models, a virtual detector plane can be associated with the detector in which each CB projection can be sampled in the virtual detector plane. In these detectors, the grid of sampling points is be planar, but not necessarily equidistant Cartesian.

CBCT scanners include one or more image processing devices that reconstruct the acquired images by executing one or more particular reconstruction algorithms, and typically include one or more viewing consoles for displaying reconstructed images, and is configured and adapted to allow an operator, such as a CT technician or radiologist, to operate the device, as well as obtain and/or record one or more images obtained by the scanner.

A number of CT systems, including CBCT, and methods for collimating, processing and forming an image using such systems are known in the art, and exemplified, without limitation, in U.S. Pat. Nos. 7,424,090, 7,418,082, 7,412,029, 7,397,887, 7,396,162, 7,386,088, 7,379,529, 7,375,338, 7,372,937, 7,339,174, 7,317,819, 7,310,411, 7,308,072, 7,305,063, 7,292,717, 7,292,674, 7,289,599, 7,249,886, 7,245,697, 7,233,644, 7,209,535, 7,203,272, 7,187,750, 7,176,466, 7,151,817, 7,147,372, 7,145,981, 7,142,633, 7,116,749, 7,113,570, 7,103,137, 7,101,078, 7,099,428, 7,085,345, 7,076,023, 7,072,444, 7,072,436, 7,058,159, 7,050,534, 7,046,757, 7,042,975, 7,027,558, 7,023,956, 7,020,232, 7,015,477, 7,015,460, 6,865,246, 6,842,502, and 6,735,277; as well as U.S. Patent Appl. Publ. Nos. 20080253516, 20080226018, 20080212860, 20080212735, 20080205727, 20080205587, 20080205585, 20080192886, 20080187195, 20080165923, 20080165918, 20080144904, 20080137802, 20080118032, 20080116386, 20080112531, 20080104530, 20080095305, 20080095301, 20080089468, 20080061241, 20080031507, 20070269001, 20070172026, 20070140410, 20070104310, 20070003010, 20060269049, 20060262898, 20090292898, 20060067464, 20060002506, 20030235265, 20030202637, and 20030043957, the contents of each of which is specifically incorporated herein in its entirety by express reference thereto.

### Collimation in CBCT

Collimators in CBCT systems are designed to acquire customized field of view (FOV) for a smaller object and to reduce radiation dose and scatter effect. In most applications, only a region of interest (ROI) within a large body needs to be imaged and acquired for reducing radiation exposure to patients. However, the reconstructed ROI image from incomplete projections may contain severe artifacts.

In the example that follows, an imaging method is described, which customizes a small ROI within an object by applying adjustable collimators and a simple and practical reconstruction by truncation correction in order to reduce a large amount of unnecessary radiation dose and to obtain tolerable image quality of the reconstructed image compared with that without ROI imaging.

In the studies described herein, ROI imaging was performed by setting transversely and longitudinally movable lead collimators between X-ray source and the object. The ROI is constrained to a small area within an object. Entrance dose has been utilized for estimating the radiation dose absorbed in the body and conduct experiments for measuring radiation dose with ROI imaging. Two reconstruction techniques for possibility of overcoming truncation problems were investigated: one was the truncation correction technique with the Feldkamp, Davis, Kress (FDK) algorithm and the other was π-line reconstruction algorithm.

The truncation correction technique was applied with FDK to reconstruct the image of cylindrical polystyrene with water as background. The imaged regions are small circles with diameters of 70- and 94-mm. From the radiation dose measurement, it was found that at least 60% and 70% of radiation dose was reduced in each of ROI imaging. Furthermore, the image quality was still acceptable with little variation of image gray values; however, it was not possible using the analytical reconstruction algorithms employed to fully reconstruct a ROI that was totally encompassed by the object.

A truncation correction technique was applied to ROI imaging with ROI within the object, and a surprising discovery was made: at least half of radiation dose could be reduced without sacrificing significant image quality. These results demonstrated that the use of collimators to reduce radiation dose during CBCT imaging represents a fundamental change in the way medical CT imaging may be performed in the future.

### Computing Devices and Programmed Media

The detection, acquisition, analysis, and display of CT images collected using the disclosed methods and apparatus may conveniently be implemented using a conventional general purpose computer or micro-processor programmed according to the teachings of the present invention, as will be apparent to those skilled in the computer arts. Appropriate software may readily be prepared by programmers of ordinary skill based on the teachings of the present disclosure, as will be apparent to those skilled in the software arts. Exemplary computers may include a motherboard that contains a CPU, memory (e.g., DRAM, ROM, EPROM, EEPROM, SRAM, SDRAM, Flash-RAM, or the like), and other optional special purpose logic devices (e.g., ASICS, and the like) or configurable logic devices (e.g., GAL, reprogrammable FPGA, and the like). The computer also includes plural input devices, including, without limitation, a keyboard and a mouse, one or more display/graphics card or adaptors for controlling the output to one or more monitor or display devices. Additionally, the computer may include removable media devices, such as, without limitation, a compact disc, magnetic tape, removable magneto-optical media, and the like); and one or more fixed, or high-density media drives including, without limitation, a “hard disk,” connected using an appropriate device bus (e.g., a SCSI bus, an Enhanced-IDE bus, an Ultra-DMA bus, and the like). The computer may also include a compact disc reader, a compact disc reader/writer unit, which may be connected to the same device bus or to another device bus.

Examples of computer readable media associated with the present invention include, without limitation, compact discs, hard disks, magnetic tapes, magneto-optical disks, programmed read-only memory (e.g., without limitation, EPROM, EEPROM, Flash-EPROM, and the like), DRAM, SRAM, SDRAM, Rambus-DRAM, etc. and one or more combinations thereof. Stored on any one or on a combination of these computer readable media, the present invention includes software for controlling both the hardware of the computer and for enabling the computer to interact with a human user. Such software may include, without limitation, one or more device drivers, one or more operating systems and one or more user applications, including development tools and the like. Computer program products of the present invention include any computer readable medium which stores computer program instructions (e.g., computer code devices) which when executed by a computer causes the computer to perform the method of the present invention. The acquired data may be digitized, if not already in digital form, and alternatively, the source of image data being obtained and processed may be a memory storing data produced by an image acquisition device, and the memory may be local or remote, in which case a data communication network may be used to access the image data for processing according to the present invention.

### EXAMPLE

The following example is included to demonstrate illustrative embodiments of the invention. It should be appreciated by those of skill in the art that the techniques disclosed in the example that follows, represent techniques discovered by the inventors to function well in the practice of the invention, and thus can be considered to constitute preferred modes for its practice. However, those of ordinary skill in the art should, in light of the present disclosure, appreciate that many changes can be made in the specific embodiments which are disclosed and still obtain a like or similar result without departing from the spirit and scope of the invention.

### Example 1

### Region of Interest Reconstruction and Dose Reduction Estimation in Collimated CBCT Imaging

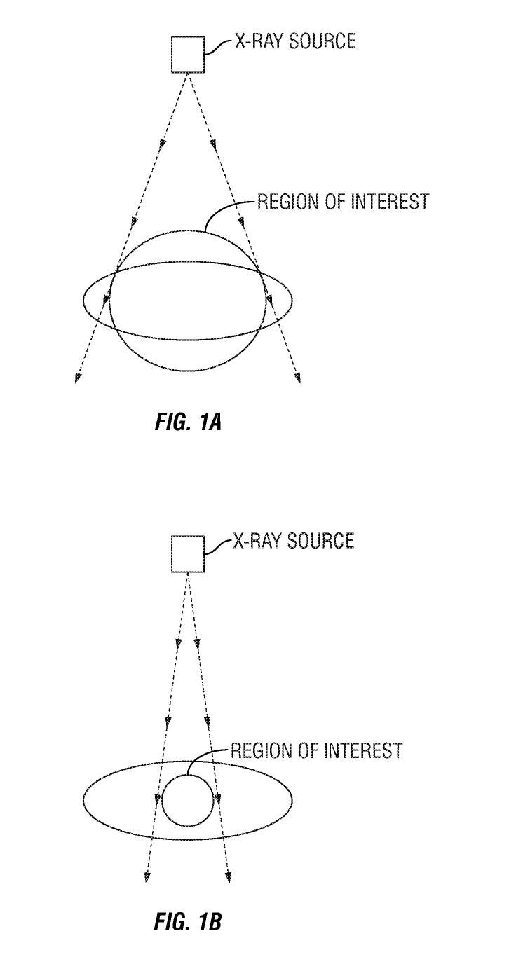

When objects or bodies extend outside scan FOV, there is abrupt discontinuity at the edges of detector, and projection data is truncated since missing data outside the detector is theoretically assumed to be zero during CBCT reconstruction. In practice, nearly all of the reconstruction algorithms in CBCT scanners are based on the FDK algorithm. Performing one-dimensional (1-D) filtering on truncated projection data leads to bright band artifacts extending inside scan FOV and incorrect reconstruction around the edges of scan FOV⁷. FIG. 1A shows an example of region of interest (ROI) imaging with mild truncation on projection data commonly encountered due to limitation of detector size. The object is entirely visible at several views, but truncation occurs at the other views. Several analytical reconstruction algorithms^{8,9} in the backprojection-filtration (BPF) family can exactly reconstruct ROI images from projections with mild truncation. As ROI is completely included in the object (FIG. 1B) and undergoes severe truncation, projection images at all views contain truncations. This case is well known as an interior problem and is not solvable by analytical approaches. An alternative possible method is the iteration reconstruction, in which forward projection is formulated as

Wf=p, (1)

where f represents the image vector, p the projection vector, and W the weighting matrix. Equation (1) is expressed as a linear equation from line integral (Radon transform). The image vector f can be obtained by solving the inverse problem in least square sense. As described previously, biased but informative solutions can be iteratively computed¹⁰. However, it lacks computation speed, and due to severe truncation, little information in p is available to increase accuracy of the reconstructed image, f.

A number of truncation correction techniques commonly implemented on mildly truncated projections as the case in FIG. 1A have been proposed using extrapolation on missing data. Ohnesorge et al. has proposed a symmetric mirroring extrapolation at the edges of truncated projections¹¹. After extrapolation, a cos-type weighting which smoothens transition of extrapolated data to the base line was applied. Hsieh et al. extrapolated the truncated projections, because total attenuation for each projection would theoretically remain constant as if there was no truncation¹². The scanned object was assumed to be a water cylinder, and the magnitudes and slopes at the edge of truncated projections were used to estimate the portion of the water cylinder that extends beyond the original projections within FOV and fits missing parts. The amount of extended projection was adjusted according to the constant total attenuation estimated at non-truncated scan views. Other models for extrapolation such as a square root of quadratic functions¹³ and linear prediction^{14,15} were explored.

When changes of 3-D images are confined to a small region during interventions, ROI imaging is applied during the second scan in order to save radiation dose. Projections are generally truncated at all views as in FIG. 1B. Missing data during the second scan of ROI imaging can be approximately recovered from the previously acquired projections ¹⁶. The preliminary reconstructed ROI is registered to the previously acquired 3-D images. Similar studies using a priori information for reconstruction with limited FOV were previously discussed^{17 18}.

In this example, ROI imaging technique uses movable pieces of lead as collimators. The collimators make the scan FOV reduced such that the imaged region is as small as a circle having a diameter of approximately 70-mm, and all projections were under severe truncation at all views as shown in FIG. 1B. Dose measurement studies were conducted to demonstrate that at least half of radiation dose was reduced. The 3-D reconstruction was performed by truncation correction using the FDK algorithm as noted above. The object in ROI could still be reconstructed with acceptable image quality, and the data demonstrated that the disclosed method was a straightforward way of dealing with the challenging interior problem from a practical perspective. Furthermore, an analytical reconstruction method, called a π-line reconstruction in the BPF family, has been examined under severe truncation situation. The simulation revealed that the π-line reconstruction algorithm without truncation correction still produced the same bright artifacts as FDK does.

### Materials and Methods

ROI Imaging with Collimators

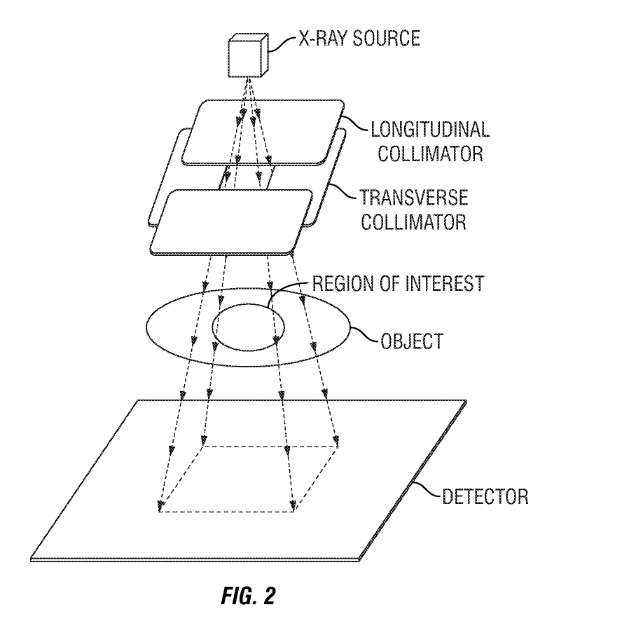

FIG. 2 illustrates the geometry of an exemplary CBCT system using collimators, and shows how such collimators may be employed in CBCT imaging. The collimators were set up between the object and the source, and could be adjusted transversely and/or longitudinally to customize an open rectangular area according to a particular ROI size. A lead shield having a thickness of about 1.1 mm can attenuate 100-kV X-ray beams to 0.1%¹⁹. If the collimators are made of lead and thick enough, X-ray beams outside the open area are greatly attenuated and can be ignored. Hence, no information is available on projections outside FOV for reconstruction with lead collimation.

ROI Imaging Truncation Correction

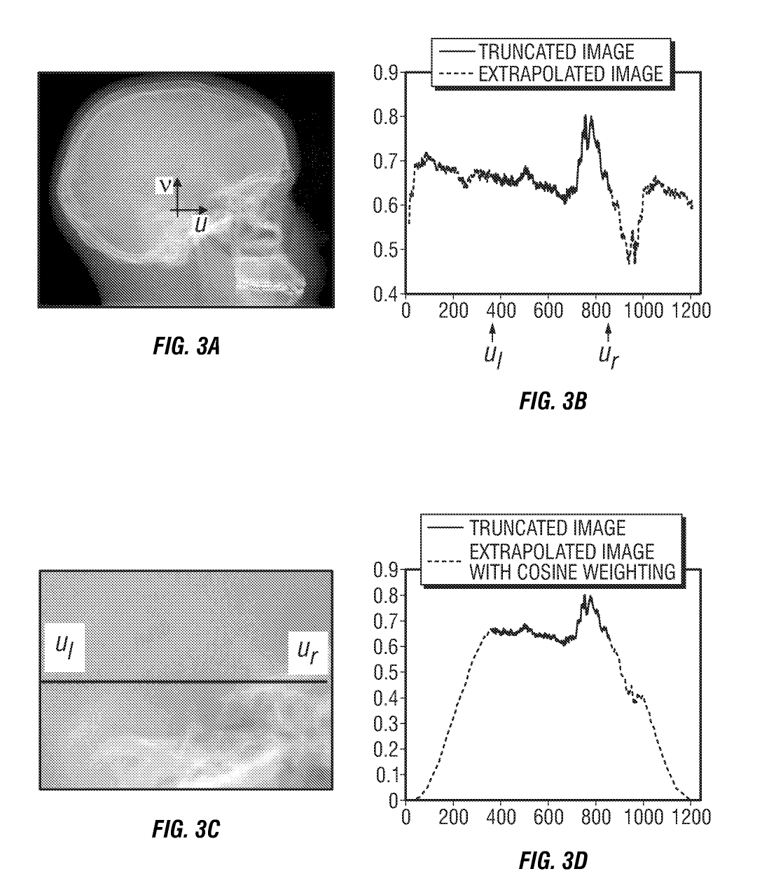

First, the truncation correction technique is as designed as follows: letting Pₖ(u,v) be the k-th projection image with u-v coordinate shown in FIG. 3A, it was assumed that it has been converted to accumulated attenuation projection from intensity-based one on the detector. Assume the reconstruction algorithm is based on FBP with 1-D filtering in u-coordinate, which is defined as the transverse direction. For simplicity, the index k of P(u,v) was ignored. The projection truncated due to reduced FOV (as illustrated in FIG. 3B) is denoted as:

$${P}_{FOV} ( u , v ) = \{ \begin{matrix}0 & u > {u}_{r} \\ 0 & u < {u}_{l} \\ P ( u , v ) & {u}_{l} \leq u \leq {u}_{r} ,\end{matrix} \qquad ( 2 )$$

where uᵣ and uₗ are determined by the right and left edges of the truncated projection P_{FOV}(u,v). Assuming the lengths for extrapolations at the both sides are Nᵣ and Nₗ with 0<Nₗ,Nᵣ<uᵣ−uₗ, based on the symmetric mirroring extrapolation technique¹¹, the extrapolated projection (FIG. 3C) is:

$${P}_{ex} ( u , v ) = \{ \begin{matrix}( 2 {P}_{FOV} ( {u}_{r} , v ) - {P}_{FOV} ( - u + 2 {u}_{r} , v ) ) , & {N}_{r} + {u}_{r} \geq u > {u}_{r} \\ ( 2 {P}_{FOV} ( {u}_{l} , v ) - {P}_{FOV} ( - u + 2 {u}_{l} , v ) ) , & {u}_{l} - {N}_{l} \leq u < {u}_{l} \\ {P}_{FOV} ( u , v ) , & {u}_{l} \leq u \leq {u}_{r} \\ 0 , & otherwise .\end{matrix} \qquad ( 3 )$$

By assuming that the image variation in ROI is small compared with the magnitudes P_{FOV}(uᵣ,v) and P_{FOV}(uₗ,v), the assumption, in general, is held for small ROI imaging of a body or head. Therefore, the extrapolated projection Pₑₓ(u,v) is positive under this assumption:

P_{FOV}(uᵣ,v)>|P_{FOV}(uᵣ,v)−P_{FOV}(−u+2uᵣ,v)|

P_{FOV}(uₗ,v)>|P_{FOV}(uₗ,v)−P_{FOV}(−u+2uₗ,v)|

To obtain smooth transition of the extrapolated data to zero, Pₑₓ(u,v) is weighted by Equation (4):

$$w ( u , v ) = \{ \begin{matrix}\frac{1}{2} ( 1 + cos ( \frac{π ( u - {u}_{r} )}{{N}_{r}} ) ) & u > {u}_{r} \\ 1 & {u}_{l} \leq u \leq {u}_{r} \\ \frac{1}{2} ( 1 + cos ( \frac{π ( u - {u}_{l} )}{{N}_{l}} ) ) & u < {u}_{l} .\end{matrix} \qquad ( 4 )$$

The weighted extrapolation is illustrated in FIG. 3D.

π-Line Reconstruction Algorithm

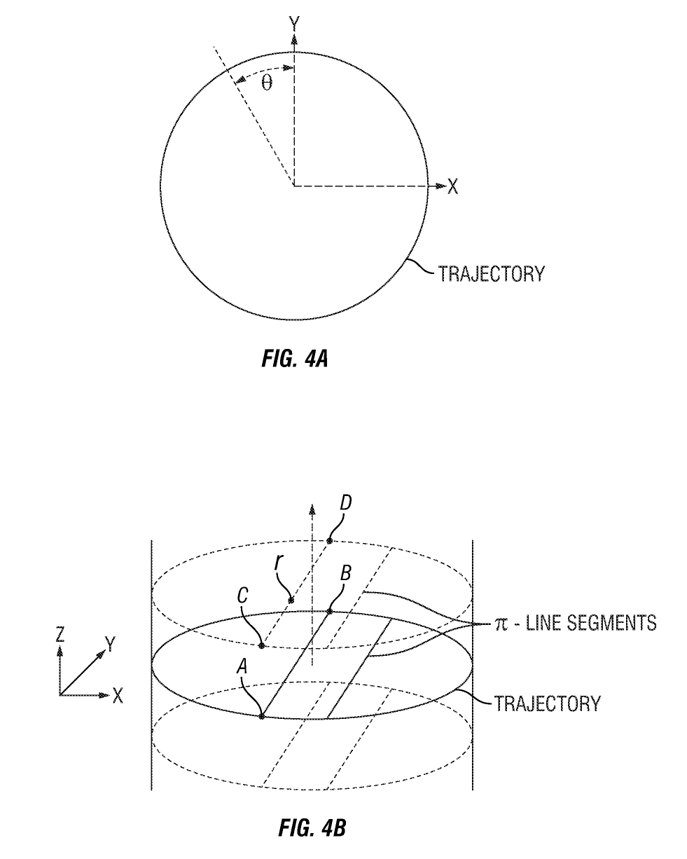

The π-line reconstruction algorithm is described below: FIG. 4A shows the geometry and the trajectory of circular CBCT in the mid-plane. θ was defined as the gantry rotational angle of the source starting from y-axis counterclockwise. The concept of a π-line originated from helical CBCT reconstruction algorithms^{20,21}, but the modification in circular CBCT geometry was first described by others²². FIG. 4B shows the 3-D view of the gantry rotation and π-line segments. The trajectory of the source lies on z=0 plane, and the imaginary trajectories (dotted circles) on the planes with z≠0. The π-line segments are defined as parallel chords on these circular trajectory and imaginary ones. Letting r=(xᵣ,yᵣ,zᵣ) be a point on the π-line segment C̅D̅ of the z=zᵣ plane and r(θ_{A}) and r(θ_{B}) points A and B on the trajectory, where θ_{A} and θ_{B} are the rotational angles of the source at A and B, all parallel π-line segments have the same direction defined by a unit vector:

$${u}_{π} = \frac{r ( {θ}_{A} ) - r ( {θ}_{B} )}{\vert r ( {θ}_{A} ) - r ( {θ}_{B} ) \vert} . \qquad ( 5 )$$

Assuming that the π-line segment A̅B̅ has the same x and y coordinates as the C̅D̅ except that they are at different z planes, the point r in 3-D space with a specific π-line direction u_{π} can be uniquely determined by a quadruple (λ,θ_{A},θ_{B},zᵣ) as

r=r(θ_{A})+zᵣu_{z}+λu_{π} (6)

where λε[0,1], and u_{z}=(0,0,1). The reconstruction has two steps: first, back-project the projections into the π-line segments, and secondly, perform Hilbert transformation along each of π-line segments. The 3-D volume is union of π-line segments and, for simplicity, we describe the practical reconstruction of 3-D images only on a π-line segment based on theoretical results previously described²¹.

Considering the π-line segment, C̅D̅, and letting P_{θ}(u,v) be the projection image at some rotational angle θ with the same u-v coordinate mentioned above, and letting L be the distance between the source and the detector, by Equation (6), r is equivalent to (λ,θ_{A},θ_{B},zᵣ). The back-projected image b(λ,θ_{A},θ_{B},zᵣ) or b(r) on the π-line segment C̅D̅ is expressed as:

$$b ( λ , {θ}_{A} , {θ}_{B} , {z}_{r} ) = {\int }_{{θ}_{A}}^{{θ}_{B}} \frac{{L}^{2}}{{( R + x sin θ - y sin θ )}^{2}} \frac{\partial }{\partial u} {( \frac{R}{\sqrt{{u}^{2} + {v}^{2} + {L}^{2}}} {P}_{θ} ( u , v ) ) }_{( u , v ) = ( {u}_{r} , {v}_{r} )} d θ + \frac{{P}_{{θ}_{B}} ( {u}_{r} , {v}_{r} )}{d ( r , {θ}_{B} )} - \frac{{P}_{{θ}_{A}} ( {u}_{r} , {v}_{r} )}{d ( r , {θ}_{A} )} . \qquad ( 7 )$$

where d(r,θ) was defined as the distance between r and r(θ). P_{θ}(uᵣ,vᵣ) is the line-integral which starts from the source at the rotational angle θ, passes through the point r, and ends at a point (uᵣ,vᵣ) on the detector.

Finally, the reconstructed image along the π-line segment C̅D̅ is:

$$\hat{f} ( λ , {θ}_{A} , {θ}_{B} , {z}_{r} ) = \frac{1}{2 π} H \{ \sqrt{( {λ}_{B} - λ ) ( λ - {λ}_{A} )} b ( λ , {θ}_{A} , {θ}_{B} , {z}_{r} ) \} + \frac{1}{2 π \sqrt{( {λ}_{B} - λ ) ( λ - {λ}_{A} )}} ( {P}_{{θ}_{A}} ( {u}_{c} , {v}_{c} ) + {P}_{{θ}_{B}} ( {u}_{c} , {v}_{c} ) ) , \qquad ( 8 )$$

where c is the midpoint of C̅D̅, and H{a(λ)} is the Hilbert transform of a(λ). [λ_{A},λ_{B}] is an interval such that {r(θ_{A})+zᵣu_{z}+λu_{π}|λε[λ_{A},λ_{B}]} includes support set of the object and belongs to the segment C̅D̅.

Calculation of Radiation Dose Reduction

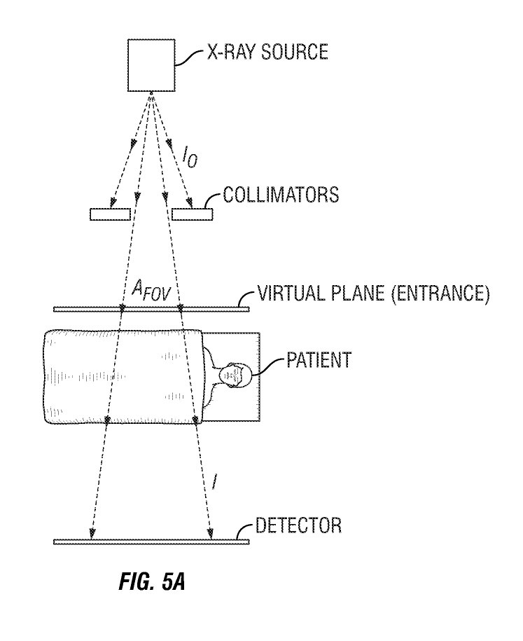

An “entrance dose” of X-rays is the dose absorbed at surface of the skin where X-ray beams enter. An X-ray beam enters the body from the direction of the X-ray tube. A small share of the beam exits from the body on the opposite side, where it exposes the detector. The share of the beam that never exits from the body is absorbed as extra energy by the body's internal organs and bones. Between the collimators and the patient, imagine that there is a virtual plane parallel to the detector and close to the top of the patient illustrated in FIG. 5A. It could be viewed as a virtual entrance to the patient X-ray beams are about to enter. The entrance dose is thus defined as energy of X-ray beams passing through the virtual plane.

Letting X-ray intensity be a unit of energy per unit area, and assuming that the energy which is obtained by integrating the X-ray beam intensity with a small sphere surrounding the X-ray source is Eₛ in FIG. 5B, the source-to-virtual-plane distance be d, O the origin of the coordinate system of the virtual plane, and r the distance between the source and a arbitrary point Q on the virtual plane. Thus, the intensity I_{O} at the point O is given by

$${I}_{O} = \frac{{E}_{s}}{4 π {d}^{2}} , \qquad ( 9 )$$

where 4πd² is the surface area of a sphere with radius d. Assuming that the coordinate of the point Q is (x,y), then the intensity I_{Q} at the point Q is

$${I}_{Q} = \frac{{E}_{s}}{4 π ( {d}^{2} + {x}^{2} + {y}^{2} )} . \qquad ( 10 )$$

From Equation (9) and Equation (10), I_{Q} becomes

$${I}_{Q} = {I}_{O} \frac{{d}^{2}}{( {d}^{2} + {x}^{2} + {y}^{2} )} . \qquad ( 11 )$$

The obliquity effect occurs since surface of the detector is not perpendicular to the direction of X-ray beams propagation. In FIG. 5C, the X-ray beams vertically pass through the origin O of the virtual plane, and denote the cross-section unit area of the X-ray beams as A_{O}. The cross-section area of the X-ray beams on the virtual plane becomes A_{Q}=A_{O}/cos θ when the same X-ray beams with cross-section unit area A_{O} are projected onto the point Q, with an angle, θ. The measured intensity I_{Q} due to obliquity alone is

I_{Q}′=I_{Q} cos θ (12)

where cos

$$θ = \frac{d}{r} .$$

The combination of inverse square law and obliquity effect is multiplicative. From Equation (11) and Equation (12), the overall intensity at the point Q is given by:

$${I}_{Q}^{′} = {I}_{O} \frac{{d}^{3}}{{( {d}^{2} + {x}^{2} + {y}^{2} )}^{\frac{3}{2}}} . \qquad ( 13 )$$

Letting the area projected on the virtual plane within FOV be A_{FOV} shown in FIG. 5A, the entrance dose D_{E} was calculated by integrating I_{Q}′ over the area A_{FOV} as set forth in Equation (14):

$${D}_{E} = {\int \int }_{{A}_{FOV}} {I}_{Q}^{′} d A . \qquad ( 14 )$$

Letting A_{FOV,m} be the maximal area on the virtual plane when full-field imaging is applied, and denoting the entrance dose as D_{E,m}, entrance dose was defined relative to that in the full field imaging in Equation (15) as:

$${D}_{\%} = \frac{{D}_{E}}{{D}_{E , m}} \times 100 \% , \qquad ( 15 )$$

i.e., D_{%} is the entrance dose relative to the maximal entrance dose D_{E,m}.

Measurement of Radiation Dose

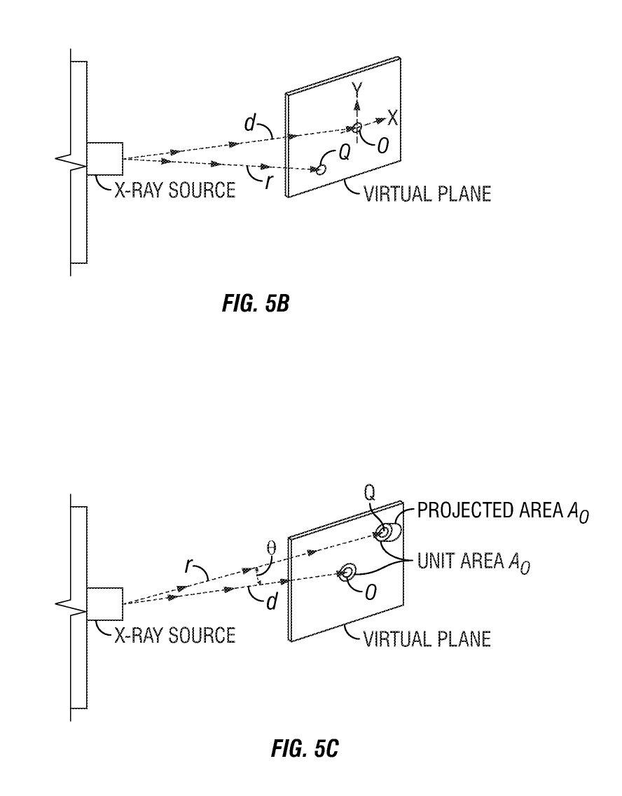

Dose measurement in the study was made using a cylindrical CT dose-index (CTDI) phantom with a diameter of 160 mm. This is the standard Perspex® CTDI head phantom with a central hole and four peripheral holes 10-mm below the surface. FIG. 6 shows the head phantom during CBCT scans from the longitudinal view and the two locations at which a CT chamber is inserted (two solid points). The CT chamber was inserted either in the center or in the peripheral position during each CBCT scan. The gantry rotation was over β=−90°˜130°. The measured doses, R, are given in Roentgen units. The relationship between measured doses R and CTDI₁₀₀ is given by Equation (16):

CTDI₁₀₀=0.876×2×R (16)

where 2 is a modified factor for the specific CT chamber in the measurement, and 0.876 is a factor converting Roentgen units into rads in air. The weighted dose CTDI_{w} was also calculated from Equation (17) as:

CTDI_{w}=⅓CTDI_{100,c}+⅔CTDI_{100,p}, (17)

where CTDI_{100,c} and CTDI_{100,p} are measured doses at the center and at the peripheral, respectively.

### Results

The CBCT imaging of the described studies were based on the C-arm flat panel (FP) CT system (Siemens Medical Solutions, Forchheim, Germany), and the parameters of CBCT system are given in Table 1. The collimators were made of lead with a thickness of 5 mm, which was enough to attenuate the intensity of X-ray beams close to zero. Two collimator pieces are movable in the transverse direction, while the two remaining collimator pieces are movable in the longitudinal direction as illustrated in FIG. 2. When the open area is large enough to allow the X-ray beams to be projected onto the full field of the detector, the full field imaging was denoted as being “without collimation.” When the collimators are adjusted to customize a smaller open area so that only ROI imaging is applied, this was denoted as being “with collimation.” In the “with collimation” imaging, the transverse length and longitudinal width of rectangular projection images are defined as Cₜ and Cₗ, respectively.

FDK & π-Line Reconstruction Under Severe Truncation Correction

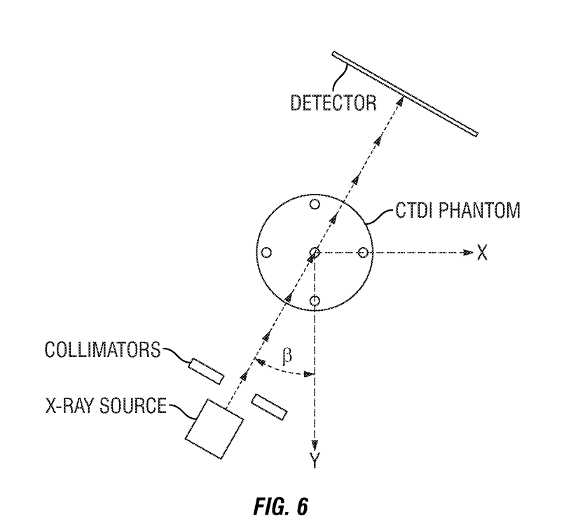

Using a head phantom with tissue- and bone-like materials as an object, two studies were conducted: the first was “without collimation” imaging, and the other was “with collimation” imaging with Cₜ=130 mm and Cₗ=130 mm. The reconstructions were the FDK algorithm and π-line BPF algorithm, each of which is applied in both studies. The projection images were stored as integers within the range [32,4096], and were scaled to [0,1]. FIG. 7 shows the reconstructed images with a display window [0.002,0.007] in the mid-plane (z=0). In FIG. 7B and FIG. 7D, only the ROI within FOV are displayed, and the bright artifacts are produced under severe truncation.

ROI Reconstruction

Cylindrical polystyrene (about −30 HU) was used with a diameter of 30 mm and height of 25 mm as the object in the ROI and water as the background. The cylindrical polystyrene was stacked above a cylindrical plastic water phantom (about 30 HU) in a tank of water. These materials and background provide constant attenuation coefficient that clearly demonstrated the variation of ROI images in the “with collimation” imaging. The projection of the cylindrical polystyrene is approximately in the isocenter of the detector at all views.

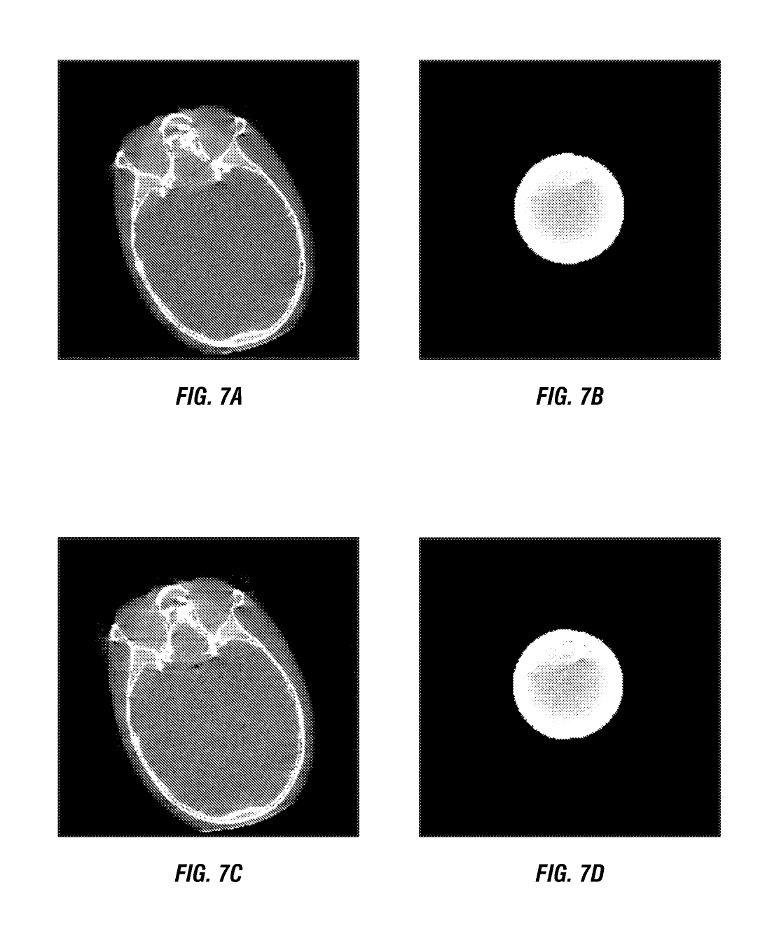

Three studies were performed: one “without collimation” imaging, another “with collimation” imaging with Cₜ=150 mm and Cₗ=83 mm and the third “with collimation” imaging where Cₜ=110 mm and Cₗ=77 mm. The later study “with collimation” imaging was conducted with the smallest FOV, which enabled the projection of the cylindrical polystyrene to exactly fit within FOV at all views. The CBCT 3-D reconstruction used the FDK algorithm with ring correction, scatter correction, and overexposure correction in the CBCT system. In the “with collimation” imaging, the truncation correction described above was applied on projection images before FDK reconstruction. The extrapolation lengths Nᵣ and Nₗ were assumed to be one-half Cₜ. FIG. 8 shows the reconstruction of these three studies with Hounsfield units on the mid-plane (z=0), on which the circular trajectory of CT scan lies. Only the ROI imaged within FOV in FIG. 8B and FIG. 8C is displayed.

Simulation for Entrance Dose

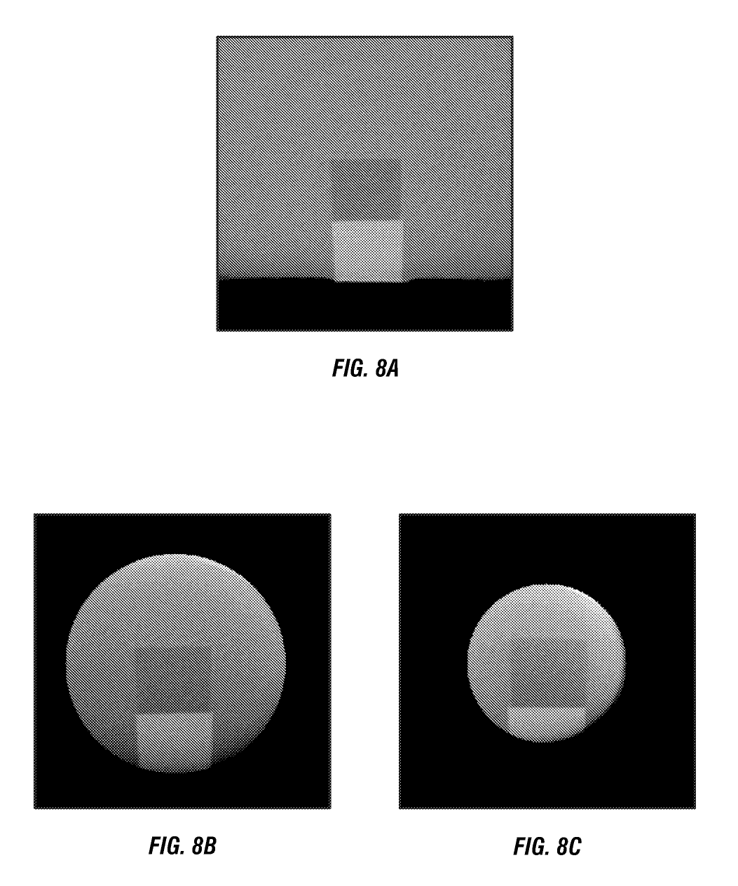

In these simulations, the calculation of entrance dose was based on parameters of the C-arm flat panel (FP) CT system shown in Table 1. The estimated source-to-virtual-plane distance was 650 mm, and the estimated A_{FOV,m} 35213.75 mm² (162.5×216.7 mm²), which was A_{FOV} when the “without collimation” imaging is applied. FIG. 9 shows the D_{%} versus A_{FOV} with a fixed ratio of width-to-length of 3:4, and a logarithmic (base 10) scale was used for the A_{FOV} axis.

Radiation Dose Measurement with Collimation

The radiation doses were measured with varying open areas of transverse and longitudinal collimators. The size Cₜ×Cₗ of full field (“without collimation”) was 385×295 mm², and its measured doses, tube voltages, and tube current at the center and at the peripheral were 2.35 Roentgen, 79 kV, and 251 mA; and 2.03 Roentgen, 79 kV, and 251 mA, respectively. Two studies were conducted: one only varied the length Cₜ with the fixed Cₗ=295 mm, while the other varied both length Cₜ and width Cₗ. The doses, tube voltages, and tube currents at the center and peripheral were measured in these two studies as shown in Table 2 and Table 3.

It is worth noticing that the doses were not lower at the smallest open areas (Cₗ=25 mm) of collimators in Table 2 and Table 3. The tube voltages and currents for Cₗ=25 mm in Table 2 and Table 3 were above 90 kV and below 220 mA compared with the others at about 80 kV and 250 mA. This can be explained by the automatic exposure control in the CBCT system. The tube voltage of X-ray beams would be automatically increased for fewer photons detected on the detector. Due to the exposure control mechanism, it was not possible to use the same tube voltage and current for all the measurements. It was also not possible to scale the doses to those with fixed tube voltage and current due to lack of relationship of dose and tube parameters under collimated imaging. For the other measurements, the variation of tube voltages and currents was within 5% relative to 80 kV and 250 mA, and the measured doses were still reliable in this study.

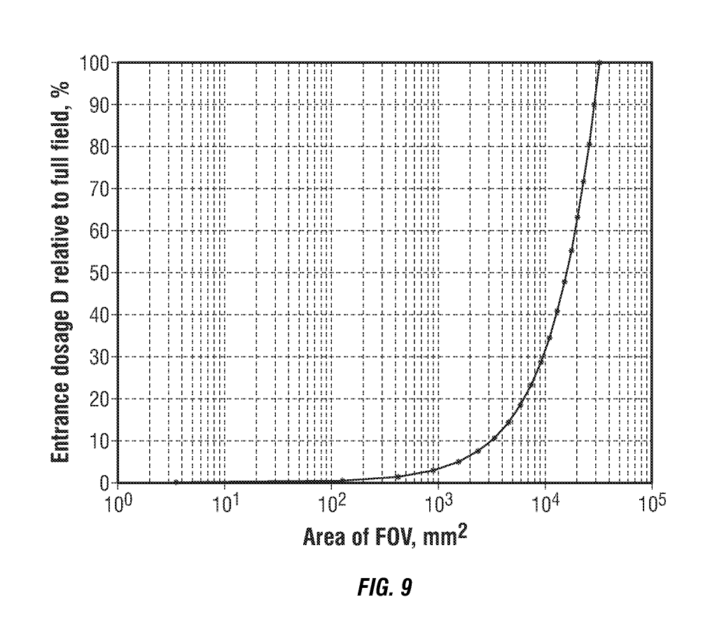

The dose for full-field (i.e., “without collimation”) was denoted as 100%. FIG. 10 shows the dose relative to full-field (i.e., “without collimation”) versus varying areas within FOV, and illustrate the studies as performed according to Table 2 and Table 3. A logarithmic (base 10) scale was used for the axis of areas. As mentioned above, the doses for Cₗ=25 mm in FIG. 10 were lower than those where Cₗ=85 mm.

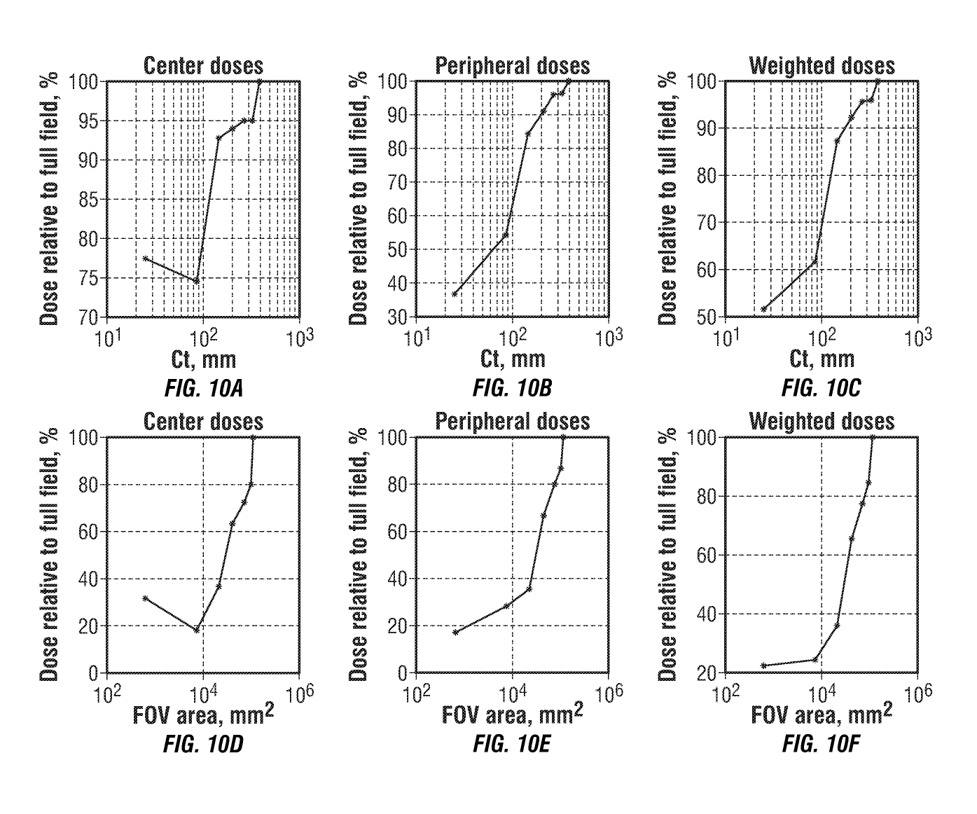

The main purpose of simulating the two analytical reconstruction algorithms (FDK and π-line) in FIG. 7 was to explain the impossibility of ROI reconstruction under the severe truncation defined in FIG. 1B. FIG. 11A illustrates an object under ROI imaging with two π-line segments, L₁ and L₂. It could be observed that L₁ passes through the support set of the object in ROI, but part of intersection of L₂ with the object was not within the ROI. During the π-line reconstruction, each projection contained sufficient information for back-projection onto the L₁ regardless of partial truncation, but that was not the case for L₂. It was not possible to obtain correct reconstruction along L₂ when performing filtering on incompletely back-projected images, which explains why artifacts appeared only when there was missing data in the filtered images. When the ROI was entirely within the object (as in FIG. 11B), every π-line segment, such as L₃, contains part of the object outside the ROI. Like FBP analytical reconstruction algorithms, it is impossible for BPF reconstruction algorithms to avoid filtering on insufficient data when the ROI is inside the object.

In the studies involving ROI reconstruction, the object of interest is the cylindrical polystyrene with water as the background. Two studies were performed using moderate (FIG. 8B) and smallest (FIG. 8C) FOV to demonstrate feasibility of a proper 3-D reconstruction even using severe truncation. The gray values approaching the border of ROI in the “with collimation” imaging were distributed less uniformly than the “without collimation” imaging, but the variation of gray values was acceptable for recognition of the ROI image. From FIG. 10, it was determined that the weighted doses were decreased by at least 60% and 70% in both “with collimation” studies. This substantial reduction in radiation dose enables one now to rethink collimated ROI imaging with only slight, or insignificant, loss of image quality. Exploiting the limit of ROI, an object the size of a coin was small enough to demonstrate the possibility of ROI reconstruction with even the smallest fields of view.

It was observed that the extrapolation technique in truncation correction with the FDK reconstruction could largely recover ROI image with an extremely small ROI. The various filter kernels in the FDK algorithms were derived from the ramp filter, which is formed by Sinc function. The feature of the filters is that their impulse responses decay fast toward both sides. Since the FDK reconstruction is involved with convolution of the filter and projections, the reconstructed images toward isocenter do not undergo significant distortion. If one properly extends the truncated projections by extrapolation, it mitigates the variation of reconstructed images caused by filtering truncated projections. The distortion in gray values becomes more obvious for reconstructed images far away from isocenter. Therefore, if a larger angle of FOV is applied, the distortion of the object in ROI will be lessened. This effect was clearly demonstrated in FIG. 8B and FIG. 8C, although it was observed that there still exists a trade-off between image quality and the angle of FOV.

The radiation dose calculation in computer simulations can be performed by Monte Carlo calculations in which photoelectric effect and scattering of photons are randomly chosen according to the probability distribution of the mass attenuation coefficient of a voxel in a simulated object. Validation of the Monte Carlo simulation has been described in detail elsewhere²³⁻²⁵. However, the dose calculation is still impractical, since the calculated dose distribution varies from object to object using the same CT system. The calculation of entrance dose in FIG. 9 provides a good representation for estimating the reduction in radiation dose in the collimated CT imaging. The amount of entrance dose may serve as an appropriate indicator of how much radiation dose the patient would be potentially exposed to.

TABLE 1
PARAMETERS IN EXEMPLARY CBCT SYSTEMS

| | |
|---|---|
| Source-to-detector distance | 1200 mm |
| Source-to-isocenter distance | 750 mm |
| Size of the detector | 300 × 400 mm² |
| Size and resolution of projection images | 1240 × 960 |
| | (0.308 mm × 0.308 mm) |
| Number of projections | 543 |
| Scan angle | 220° |
| Scan time | 20 s |

TABLE 2
MEASURED DOSES, TUBE VOLTAGES, AND TUBE CURRENTS
WITH FIXED Cₗ = 295 mm

| | Center | | | Peripheral | | |
|---|---|---|---|---|---|---|
| Cₜ | Dose | kV | MA | Dose | kV | mA |
| 25 mm | 1.82 | 92 | 216 | 0.74 | 92 | 217 |
| 85 mm | 1.75 | 78 | 257 | 1.10 | 78 | 256 |
| 145 mm | 2.18 | 80 | 249 | 1.71 | 80 | 249 |
| 205 mm | 2.21 | 80 | 251 | 1.85 | 80 | 250 |
| 265 mm | 2.23 | 80 | 250 | 1.95 | 79 | 251 |
| 325 mm | 2.23 | 80 | 250 | 1.96 | 79 | 251 |

TABLE 3
MEASURED DOSES, TUBE VOLTAGES, AND TUBE CURRENTS
WITH VARYING SIZES

| | Center | | | Peripheral | | |
|---|---|---|---|---|---|---|
| Cₜ × Cₗ | Dose | kV | mA | Dose | kV | mA |
| 25 × 25 mm² | 0.743 | 98 | 203 | 0.343 | 97 | 204 |
| 85 × 85 mm² | 0.422 | 80 | 250 | 0.571 | 83 | 240 |
| 145 × 145 mm² | 0.861 | 77 | 260 | 0.72 | 81 | 247 |
| 205 × 205 mm² | 1.49 | 80 | 248 | 1.35 | 80 | 249 |
| 265 × 265 mm² | 1.70 | 80 | 250 | 1.63 | 76 | 261 |
| 325 × 295 mm² | 1.89 | 79 | 251 | 1.76 | 79 | 251 |

### REFERENCES

The following references, to the extent that they provide exemplary procedural or other details supplementary to those set forth herein, are specifically incorporated herein in their entirety by explicit reference thereto:
1. Yu R., Conover D. “Flat panel detector-based cone-beam volume CT angiography imaging: system evaluation,” Medical Imaging, IEEE Transactions, 19:949-963, 2000.
2. Feldkamp L. A., Davis L. C., Kress J. W. “Practical cone-beam algorithm,” J. Opt. Soc. Am., 1:612-619, 1984.
3. Zellerhoff M., Scholz B., Ruehrnschopf E. P., Brunner T. “Low contrast 3D reconstruction from C-arm data.” Proc. SPIE, 5745:646, 2005.
4. Prince J. L., Links J. M. “Medical imaging signals and systems,” Upper Saddle River, NJ: Pearson Prentice Hall, 2006.
5. Siewerdsen J. H., Jaffray D. A. “Cone-beam computed tomography with a flat-panel imager: Magnitude and effects of X-ray scatter,” Med. Phys., 28:220, 2001.
6. Moore C. J., Marchant T. E., Amer A. M. “Cone beam CT with zonal filters for simultaneous dose reduction, improved target contrast and automated set-up in radiotherapy,” Phys. Med. Biol., 51:2191-204, 2006.
7. Gore J. C., Leeman S. “The reconstruction of objects from incomplete projections,” Phys. Med. Biol., 25:129-136, 1980.
8. Yu L., Zou Y., Sidky E. Y., Pelizzari C. A., Munro P., Pan X. “Region of interest reconstruction from truncated data in circular cone-beam CT,” Medical Imaging, IEEE Transactions 25:869-881, 2006.
9. Noo F., Clackdoyle R., Pack J. D. “A two-step Hilbert transform method for 2D image reconstruction,” Phys. Med. Biol., 49:3903-3923, 2004.
10. Zhang B., Zeng G. L. “Two-dimensional iterative region-of-interest (ROI) reconstruction from truncated projection data,” Med. Phys., 34:935, 2007.
11. Ohnesorge B., Flohr T., Schwarz K., Heiken J. P., Bae K. T. Efficient correction for CT image artifacts caused by objects extending outside the scan field of view. Med. Phys., 27:39, 2000.
12. Hsieh J., Chao E., Thibault J. et al. “A novel reconstruction algorithm to extend the CT scan field-of-view,” Med. Phys., 31:2385, 2004.
13. Sourbelle K., Kachelriess M., Kalender W. A. Reconstruction from truncated projections in CT using adaptive detruncation. Eur. Radiol., 15:1008-1014, 2005.
14. Rajgopal K., SrlNlVasa N., Ramakrishnan K. R. Image reconstruction from incomplete projection data: A linear prediction approach. Medical Imaging Systems Techniques and Applications, 1997.
15. Anoop K. P., Rajgopal K. Estimation of Missing Data using Windowed Linear Prediction in Laterally Truncated Projections in Cone-Beam CT. Engineering in Medicine and Biology Society, 2007. EMBS 2007. 29th Annual International Conference of the IEEE 2903-2906, 2007.
16. Wiegert J., Bertram M., Netsch T., Wulff J., Weese J., Rose G. “Projection Extension for Region of Interest Imaging in Cone-Beam CTI,” Acad. Radiol., 12:1010-1023, 2005.
17. Ramamurthi K., Prince J. “Tomographic Reconstruction for Truncated Cone Beam Data Using Prior CT Information. Medical Image Computing and Computer-Assisted Intervention”-Miccai 2003: 6th International Conference, Montreal, Canada, November 2003: Proceedings 2003.
18. Ruchala K. J., Olivera G. H., Kapatoes J. M., Reckwerdt P. J., Mackie T. R. “Methods for improving limited field-of-view radiotherapy reconstructions using imperfect a priori images,” Med. Phys., 29:2590, 2002.
19. Hubbell J. H. “Photon mass attenuation and energy-absorption coefficients from 1 keV to 20 MeV,” Int. J. Appl. Radiat. Isotop., 33:1269-1290, 1982.
20. Danielsson P. E., Edholm P., Seger M. “Towards exact 3D-reconstruction for helical cone-beam scanning of long objects. A new detector arrangement and a new completeness condition,” Proc. 1997 Meeting on Fully 3D Image Reconstruction in Radiology and Nuclear Medicine (Pittsburgh)(D W Townsend and P E Kinahan, eds.) 141-44, 1997.
21. Zou Y., Pan X. “Exact image reconstruction on PI-lines from minimum data in helical cone-beam CT,” Phys. Med. Biol., 49:941-959, 2004.
22. Pan X., Xia D., Zou Y., Yu L. “A unified analysis of FBP-based algorithms in helical cone-beam and circular cone- and fan-beam scans,” Phys. Med. Biol., 49:4349-4369, 2004.
23. Deak P., van Straten M., Shrimpton P. C., Zankl M., Kalender W. A. “Validation of a Monte Carlo tool for patient-specific dose simulations in multi-slice computed tomography,” Eur. Radiol., 18:759-772, 2008.
24. Schmidt B., Kalender W. A. “A fast voxel-based Monte Carlo method for scanner- and patient-specific dose calculations in computed tomography,” Physica. Medica., 18:43-53, 2002.
25. Sechopoulos I., Vedantham S., Suryanarayanan S., D′Orsi C. J., Karellas A. “Monte Carlo and Phantom Study of the Radiation Dose to the Body from Dedicated CT of the Breast,” Radiology, 247:98, 2008.

All of the methods disclosed and claimed herein can be executed without undue experimentation in light of the present disclosure. While the methods of this invention and devices, imaging systems, and computer program products employing them have been described in terms of exemplary embodiments, it will be apparent to those of ordinary skill in the art that variations may be applied to the composition, methods and in the steps or in the sequence of steps of the method described herein without departing from the concept, spirit and scope of the invention as defined by the appended claims. Accordingly, the exclusive rights sought to be patented are as set forth in the following claims:

What is claimed is:

1. A method for operating computed tomographic imaging using a radiation source and a plurality of detectors to generate an image of an object, the method comprising the steps of: a) defining desired image characteristics; b) performing calculations to determine the modulation intensity to be applied to the radiation source by at least a first aperture modulator or collimator to generate the desired image characteristics; and c) modulating the radiation source using the at least a first collimator to generate a desired pattern of fluence between the beam source and the object to be imaged.

2. The method of claim 1, wherein the desired image characteristics comprise desired levels of contrast-to-noise ratio (CNR), signal-to-noise ratio (SNR), or a combination thereof.

3. The method of claim 2, wherein the desired image characteristics providing at least one of: desired image quality in at least one defined region of interest; and at least one desired distribution of said image quality.

4. The method of claim 1 wherein performing the calculations comprises solving an inverse problem using an iterative solution.

5. The method of claim 1, further comprising defining at least a first region of interest from a library of population modules or at least one previously acquired image of the object.

6. The method of claim 1, wherein the total radiation dose to the patient is lower than that required performing the method in the absence of intensity modulation or in the absence of the at least a first collimator.

7. The method of claim 1, further comprising providing at least a first temporal modulation of the radiation source.

8. The method of claim 1, further comprising providing at least a first spatial modulation of the radiation source.

9. The method of claim 1, comprising providing both spatial and temporal modulation of the radiation source.

10. The method of claim 1, wherein the aperture modulator or collimator comprises a plurality of individual elements adapted to absorb radiation.

11. The method of claim 10, wherein the plurality of individual elements are comprised of lead, aluminum, tungsten, a dense plastic, composite or an alloy, or any combination thereof.

12. An imaging system adapted and configured to perform the method of claim 1.

13. The imaging system as claimed in claim 12, comprising at least a first aperture-modulating collimator that comprises a plurality of individual elements, each being substantially impervious to the radiation and being movable between an open position and a closed position, whereby open positions of the individual elements define an aperture permitting passage of the beam from the radiation source.

14. The imaging system of claim 12, characterized as a cone-beam computed tomography system.

15. The imaging system of claim 12, further comprising a post-processing module for enhancement of at least a first 3-D model of at least a first region of interest from within the object.

16. An examination apparatus comprising: an X-ray device for the generation of X-ray projections of the body volume from different directions, wherein projections can be based on at least two different samplings of a collimated beam of X-rays generated from the device; and the imaging system of claim 12.

17. The examination apparatus according to claim 16, wherein the X-ray device is adapted and configured to provide an intensity-modulated, collimated beam of X-rays for imaging at least a first region of interest of an object examined by the apparatus.

18. The examination apparatus of claim 16, adapted and configured as a baggage inspection apparatus, a medical diagnostic apparatus, a material testing apparatus, or a materials science analytic apparatus.

19. A record carrier, a computer-readable medium, or a computer program element wherein:
(a) the record carrier comprises a computer program for the generation of a three-dimensional model of at least a first region of interest of an object from a plurality of collimated X-ray projections, and wherein the computer program is adapted to execute at least one step of a method in accordance with claim 1;
(b) the computer-readable medium comprises a computer program for reconstructing a three-dimensional image of an object's region or volume of interest from a set of collimated cone-beam X-ray projections of the object with an examination apparatus, and wherein the computer program when being executed by a processor, is adapted to execute at least one step of a method in accordance with claim 1; or
(c) the computer program element, when being executed by a processor, is adapted to execute at least one step of a method in accordance with claim 1.

20. A method for generating a three-dimensional image of a scanned object from a plurality of cone-beam projections passed through the object and attenuated thereby, the method comprising:
(a) positioning a source at a position on a predetermined scan path;
(b) passing a projection of cone-beam X-ray radiation comprising a plurality of projection rays from the source through an object, the cone-beam projection being attenuated by at least a first collimator, and by partial absorption in the object;
(c) detecting radiation intensity of the attenuated cone-beam projection on an area detector;
(d) obtaining a two-dimensional attenuation image of the cone-beam projection from the detected radiation intensity;
(e) generating an intermediate, locally reconstructed, three-dimensional image with constant values assigned along each projection ray;
(f) at least once repeating steps (d)-(e); and
(g) summing the plurality of intermediate, locally reconstructed, three-dimensional images obtained for the plurality of cone-beam projections to obtain an ultimate, reconstructed, three-dimensional image of the object.

21. A cone-beam tomography apparatus comprising a radiation source, a radiation detector, a support for an object to be scanned by radiation from the radiation source, a computer-readable storage medium storing computer-executable software for generating a reconstruction of cone-beam radiation attenuation in an object, the software comprising: code for obtaining and generating an intermediate, locally reconstructed, three-dimensional image with constant values assigned along each projection ray; code for summing the plurality of intermediate, locally reconstructed, three-dimensional images obtained for the cone-beam projections to obtain an ultimate, reconstructed, three-dimensional image of the object; and code for displacing the source and detector relative to the support in a predetermined scan path for radiation transmitted from the source, through an object positioned by the support, and to the detector.

22. A method for forming an image of an object, the method comprising: (a) exposing the object to a cone beam of radiation rendered spatially coherent by its passage through at least a first collimator; (b) projecting the spatially coherent collimated conical beam of radiation onto the object and collecting the radiation which has passed through the object in at least a first detector to produce detected data; (c) deriving, from the detected data, at least a first image; and (d) repeating step (c) at least once to form a plurality of images of at least a first region of interest within the object.

23. A system for forming an image of an object, the system comprising: (a) a source of a cone beam of radiation rendered spatially-coherent by at least a first collimator; (b) a detector for receiving the spatially-coherent radiation which has passed through the object to produce detected data; and (c) a computer, receiving the detected data, for deriving from the detected data at least a first three-dimensional image of at least a first region of interest within the object.

24. The system of claim 23, characterized as a cone-beam computed tomography system adapted and configured for medical imaging.
